(19) United States
(12) Patent Application Publication
(10) Pub. No.: US 2007/0037692 A1
(43) Pub. Date: Feb. 15, 2007

(54) Method for stabilizing catalyst activity during MTO unit operation

(76) Inventors: James H. Beech JR., Kingwood, TX (US); Jesse Frederick Goellner, Pittsburgh, PA (US); Michael A. Risch, Seabrook, TX (US); Peter Nicholas Loezos, Houston, TX (US); Kenneth R. Clem, Humble, TX (US); Michael Peter Nicoletti, Houston, TX (US)

Correspondence Address: ExxonMobil Chemical Company;Law Technology, P.O. Box 2149, Baytown, TX, 77522-2149, US

(21) Appl. No.: 11/474,639

(22) Filed: Jun. 26, 2006

Related U.S. Application Data
(60) Provisional application No. 60/706,869, filed on Aug. 10, 2005.

(51) Int. Cl. B01J 20/34

(52) U.S. Cl. 502/56

(57) ABSTRACT

A method for maintaining the activity of silicoaluminophosphate (SAPO) molecular sieve catalyst particles during oxygenate to olefin conversion reactions. The SAPO catalyst particles are regenerated under targeted conditions in the presence of platinum to provide controlled, steady state regeneration while minimizing catalyst damage.

### CROSS REFERENCE TO RELATED APPLICATIONS

This application claims benefit of Provisional Application No. 60/706,869, filed Aug. 10, 2005, the disclosure of which is fully incorporated herein by reference.

### FIELD OF THE INVENTION

This invention relates to methods for preserving the activity of molecular sieve catalysts used during oxygenate-to-olefin conversion processes. In particular, this invention relates to methods for preserving the activity of silicoaluminophosphate molecular sieve catalysts.

### BACKGROUND OF THE INVENTION

Oxygenate to olefin conversion reactions typically involve contacting an oxygenate feedstock with a formulated molecular sieve catalyst. As the reaction proceeds, coke (a carbonaceous material) builds up on the molecular sieve catalyst. This coke is removed by passing the catalyst through a regenerator.

During the conversion reaction the molecular sieve serves as a catalyst and therefore is not directly consumed by the oxygenate conversion reaction. The molecular sieve, however, can become damaged or degraded for a variety of reasons. Damaged or degraded molecular sieve is less effective at catalyzing an oxygenate to olefin reaction. Due to the cost of replacing degraded catalyst, reducing or eliminating degradation of molecular sieve within an oxygenate to olefin reaction system is desirable.

U.S. Patent Application Publication 2003/0163010 (Xu et al.) describes a method for performing an oxygenate to olefin reaction. In Xu et al., platinum or another CO oxidation metal is added to the regenerator.

Publication WO 2005/017073 (Martens et al.) describes a method for maintaining a particle size distribution in a reaction system, such as an oxygenate to olefin reactor, by addition of co-catalyst particles. In Martens et al., particles of a combustion promoting co-catalyst can be added to a reaction system, such as particles composed of platinum or another Group VIII metal supported on aluminum oxide.

What is desired are methods that allow for more efficient conversion of oxygenates to olefins. In particular, methods are desired that allow for protection of catalyst used in such conversions during periods of extended use.

### SUMMARY OF THE INVENTION

In an embodiment, the invention provides a method for regenerating molecular sieve catalyst. The method includes receiving SAPO catalyst, having at least 5 wt % coke relative to the weight of molecular sieve in the catalyst, from a reactor in an oxygenate to olefin reaction system. The received SAPO catalyst is regenerated in a regenerator at a temperature of 730° C. or less to produce regenerated catalyst having at least 0.2 wt % coke relative to the weight of molecular sieve in the regenerated catalyst. Preferably the regenerated catalyst has at least 0.4 wt %, or more preferably 0.6 wt % coke relative to the weight of molecular sieve in the regenerated catalyst. During regeneration, the regenerator produces a steady state afterburn of 200° C. or less and a steady state CO concentration in a regenerator flue gas of 10,000 ppmv or less. Preferably, the afterburn is 100° C. or less. Preferably, the CO concentration in the regenerator flue gas is 1000 ppmv or less. As the reaction system operates, particles containing a CO oxidation metal are added to the reaction system at a rate of 10 ppmw of CO oxidation metal per total weight of unit catalyst inventory in the reaction system per day or less. Preferably, the CO oxidation metal addition rate is 0.35 ppmw or less. The concentration of CO oxidation metal in the added particles is at least 1 ppmv, preferably at least 10 ppmv.

In another embodiment, the invention provides a method for regenerating molecular sieve catalyst. The method includes receiving SAPO catalyst, having at least 5 wt % coke relative to the weight of molecular sieve in the catalyst, from a reactor in an oxygenate to olefin reaction system. The SAPO catalyst is regenerated in a regenerator at a temperature of from 540° C. to 730° C. and at a pressure of from 5 to 100 psig. This produces regenerated catalyst having from 0.4 wt % coke to 2.2 wt % coke relative to the weight of molecular sieve in the catalyst. Preferably, the regenerated catalyst has 0.6 wt % coke relative to the weight of molecular sieve in the catalyst. During regeneration, the regenerator produces a steady state afterburn of 200° C. or less, a steady state CO concentration in a regenerator flue gas of 10,000 ppmv or less, and a steady state of O₂ in the regenerator flue gas of at least 2.0 vol %. Preferably, the afterburn is 100° C. or less. Preferably, the CO concentration in the regenerator flue gas is 1000 ppmv or less. As the reaction system operates, particles containing a CO oxidation metal are added to the reaction system at a rate of 10 ppmw of CO oxidation metal per total weight of catalyst in the reaction system per day or less. Preferably, the CO oxidation metal is added to the reaction system at a rate of 0.35 ppmw or less.

In another embodiment, the invention provides a method for regenerating molecular sieve catalyst in a continuous or semi-continuous oxygenate-to-olefin reaction system, comprising: (i) receiving molecular sieve catalyst, having at least 50% of a pre-determined average coke level in an oxygenate-to-olefin reaction system, relative to the weight of molecular sieve in the catalyst, wherein the reaction system comprises at least a reactor and a regenerator, and wherein, at any given time, the reactor has an inventory (RxI) of molecular sieve catalyst and the regenerator has an inventory (RgI) of molecular sieve catalyst; (ii) regenerating the molecular sieve catalyst in the regenerator to produce regenerated catalyst having at least 0.1 wt % coke relative to the weight of molecular sieve in the regenerated catalyst, the regenerator producing a steady state afterburn of 200° C. or less and a steady state CO concentration in a regenerator flue gas of 10,000 ppmv or less, wherein the ratio of the regenerator inventory to the reactor inventory (RgI/RxI) is from about 0.1 to about 0.8; and (iii) adding particles containing a CO oxidation metal to the reaction system at a rate of 10 ppmw of CO oxidation metal per total weight of unit catalyst inventory in the reaction system per day or less, the concentration of CO oxidation metal in the particles being at least 1 ppmw. In a preferred embodiment, the steady state activity of the reaction system catalyst inventory is maintained at greater than 50% of fresh catalyst activity when making up catalyst for inventory catalyst losses.

### BRIEF DESCRIPTION OF THE FIGURES

FIG. 1 depicts data modeling a regeneration process under several conditions.

FIG. 2 depicts data modeling a regeneration process under several conditions.

FIG. 3 depicts data modeling a regeneration process under several conditions.

FIG. 4 depicts data modeling a regeneration process under several conditions.

FIG. 5 depicts data modeling a regeneration process under several conditions.

FIG. 6 depicts data modeling a regeneration process under several conditions.

FIG. 7 depicts data for platinum addition to a regeneration process according to an embodiment of the invention.

FIG. 8 depicts data for platinum addition to a regeneration process according to an embodiment of the invention.

FIG. 9 depicts data modeling a regeneration process under several conditions.

FIG. 10 depicts data modeling a regeneration process under several conditions.

### DETAILED DESCRIPTION OF THE EMBODIMENTS

### I. PROTECTING CATALYTIC ACTIVITY OF A SILICOALUMINOPHOSPHATE MOLECULAR SIEVE

This invention is directed to methods for protecting molecular sieve catalyst in an oxygenate to olefin reaction system. In an embodiment, the invention provides a method for regenerating molecular sieve catalyst using conditions that reduce or minimize damage to the molecular sieve while providing a sustainable steady state process. This is achieved by regenerating the particles under a targeted range of operating conditions. The catalyst is regenerated at a temperature of less than 730° C., preferably less than 700° C., for example less than 650° C., in the presence of a CO oxidation metal while maintaining a coke level on the regenerated catalyst of at least 0.4 weight percent relative to the weight of molecular seive after regeneration. Preferably, the coke level on the regenerated catalyst is at least 0.6 weight percent. The amount of CO remaining in the gas stream exiting the regenerator is also controlled, as is the afterburn temperature of the gas stream exiting the regenerator. The afterburn temperature refers to the change in the temperature of the gas stream, relative to the temperature of the fluidized bed, as the gas stream enters the volume above the regenerator fluidized bed and flows into the cyclones or other flue gas piping. In the discussion below, afterburn will be used to refer to both dilute phase burning of coke on entrained catalyst as well as additional combustion of CO after regenerator flue gas leaves the regenerator fluidized catalyst bed. In an embodiment, the targeted conditions allow the activity of the total catalyst inventory in a reaction system to be maintained at greater than 50% of the activity of fresh catalyst inventory. Preferably, the activity of the total catalyst inventory is maintained at greater than 60% of the activity of fresh catalyst inventory. The activity of catalyst inventory refers to a measurable reaction rate for the catalyst inventory, such as the reaction rate for converting methanol to olefin product.

In a preferred embodiment, molecular sieve catalyst is regenerated under conditions where platinum is introduced into the regenerator at a controlled rate. By controlling the rate of platinum addition to account for losses of the CO oxidation metal due to attrition, sufficient CO oxidation metal can be provided for a sustainable steady state reaction while reducing or minimizing the total amount of CO oxidation metal needed.

In another embodiment, catalyst in an oxygenate to olefin reaction system is regenerated under a controlled set of conditions in order to reduce or eliminate damage or degradation of the catalyst while providing a sustainable, steady state process. In order to achieve the reduced degradation in a sustainable process, the following conditions are simultaneously implemented in the regenerator: a regeneration temperature of from 500° C. to 650° C., preferably at least 590° C.; excess O₂ in the range of 0.5% to 2.5% by volume; a catalyst hold-up time in the regenerator of less than 180 minutes, preferably, less than 30 minutes, more preferably at least 5 minutes, and still more preferably from 20 to 25 minutes; a coke level on the regenerated catalyst of at least 0.6 wt % relative to the weight of molecular sieve; a regenerator pressure of from 20 to 30 psig; and a Pt addition rate to the regenerator of up to 10 ppmw per unit weight of unit catalyst inventory per day. Preferably, the Pt addition rate to the regenerator is up to 0.35 ppmw per unit weight of unit catalyst inventory per day. These conditions taken together allow for removal of up to 6 wt % of coke from a catalyst particle while producing an afterburn of 200° C. or less and a CO concentration in the flue gas exiting the regenerator of 10000 ppmv or less. Preferably, the conditions taken together produce an afterburn of 100° C. or less. Preferably, the CO concentration in the flue gas exiting the regenerator is 1000 ppmv or less. In the regeneration conditions provided for this embodiment, the coke level on the catalyst overall, the afterburn, and CO concentration in the flue gas can be maintained at steady state during operation. In this embodiment, selection of some variables while allowing others to vary can result in an unstable operating condition that are not operable, possibly due to excessive afterburn, inability to maintain a desired coke level on the catalyst particles, or a loss of control of other factors which would lead to catalyst damage or deactivation.

In a preferred embodiment, the invention provides a method for regenerating molecular sieve catalyst in a continuous or semi-continuous oxygenate-to-olefin reaction system, comprising: (i) receiving molecular sieve catalyst, having at least 50% of a pre-determined average coke level in an oxygenate-to-olefin reaction system, relative to the weight of molecular sieve in the catalyst, wherein the reaction system comprises at least a reactor and a regenerator, and wherein, at any given time, the reactor has an inventory (RxI) of molecular sieve catalyst and the regenerator has an inventory (RgI) of molecular sieve catalyst; (ii) regenerating the molecular sieve catalyst in the regenerator to produce regenerated catalyst having at least 0.1 wt % coke relative to the weight of molecular sieve in the regenerated catalyst, the regenerator producing a steady state afterburn of 200° C. or less and a steady state CO concentration in a regenerator flue gas of 10,000 ppmv or less, wherein the ratio of the regenerator inventory to the reactor inventory (RgI/RxI) is from about 0.1 to about 0.8; and (iii) adding particles containing a CO oxidation metal to the reaction system at a rate of 10 ppmw of CO oxidation metal per total weight of unit catalyst inventory in the reaction system per day or less, the concentration of CO oxidation metal in the particles being at least 1 ppmw. In a preferred embodiment, the steady state activity of the reaction system catalyst inventory is maintained at greater than 50% of fresh catalyst activity when making up catalyst for inventory catalyst losses.

Although, in some embodiments, the molecular sieve catalyst is identified as a silicoaluminophosphate (SAPO), it should be understood that the SAPOs are examples of molecular sieve catalysts but that other small-pore (i.e., pore size of about 5 Å or less, preferably between about 5 Å and about 3.5 Å) molecular sieve catalysts (such as aluminophosphates, aluminosilicates, and the like, intergrowths thereof, and combinations thereof), and/or molecular sieve catalysts characterized as 12-ring or less (preferably from about 6-ring to about 12-ring, more preferably of about 8-ring), whether zeolitic or non-zeolitic, can be substituted for the SAPOs disclosed herein, with the appropriate adjustments to one or more of the process conditions, as would be known to those of skill in the art and/or would be readily determinable through experimentation.

Further, as described herein, it is contemplated that embodiments listed separately, even in different aspects of the invention described herein, may be combined together with one or more other embodiments, provided that the embodiments do not have features that are mutually exclusive.

### II. REGENERATION OF MOLECULAR SIEVE CATALYST

In an embodiment, the invention provides a method for reducing or minimizing the degradation of molecular sieve catalyst during regeneration. During an oxygenated to olefin reaction, an oxygenate feedstock is contacted with a molecular sieve catalyst in a reactor. This produces the olefin product, which is separated from the catalyst in one or more disengaging vessels. During the conversion reaction, coke is deposited on the catalyst as a by-product. The buildup of coke on the catalyst is controlled by passing the catalyst through a regenerator.

In an embodiment, at least a portion of the coked catalyst composition is withdrawn from one or more of the disengaging vessels and introduced to the regeneration system. The regeneration system comprises a regenerator where the coked catalyst composition is contacted with a regeneration medium, preferably a gas containing oxygen, under conventional regeneration conditions of temperature, pressure and residence time. In an embodiment, a gas-solids flow exiting a regenerator may be passed through cyclones configured according to the invention. Alternatively, at least a portion of the catalyst can be flowed to bypass the regeneration system. The catalyst bypassing the regenerator can be flowed to another desired portion of the reaction system, such as flowing the catalyst directly into a catalyst cooler or allowing the catalyst to rejoin a fluidized bed in the reactor. Non-limiting examples of suitable regeneration media include one or more of oxygen, O₃, SO₃, N₂O, NO, NO₂, N₂O₅, air, air diluted with nitrogen or carbon dioxide, oxygen and water (U.S. Pat. No. 6,245,703), carbon monoxide and/or hydrogen.

Suitable regeneration conditions are those capable of burning coke from the coked catalyst composition to a desired level. Coke levels on the catalyst composition are measured by withdrawing the catalyst composition from the conversion process and determining its carbon content. In an embodiment, an increased level of coke remains on the catalyst after regeneration. Maintaining a higher level of coke both reduces the required regeneration time for catalyst to reach a desired coke level and increases the coke burning rate. Preferably, the regeneration conditions remove coke to less than 1.0 weight percent based on the total weight of the coked molecular sieve catalyst composition entering the regeneration system, and more preferably to less than 0.75 weight percent. Preferably, the regeneration conditions allow 0.3 weight percent or greater of coke to remain on the catalyst relative to the total weight of catalyst after regeneration, or at least 0.4 weight percent, or at least 0.5 weight percent, or at least 0.6 weight percent. In another embodiment, the regeneration conditions can allow 0.1 weight percent or greater of coke to remain on the catalyst relative to the total weight of catalyst after regeneration, or 0.2 weight percent or greater. Note that allowing at least 0.1 weight percent or greater of coke to remain on the catalyst, preferably greater than 0.2 weight percent, and more preferably greater than 0.3 weight percent, can allow for improved circulation between the regenerator and the reactor. The weight of coke on catalyst can be alternatively expressed in terms of the amount of molecular sieve present within the catalyst. The weight of molecular sieve within a catalyst will be a fraction of the total catalyst weight. The weight percent of coke relative to the weight of molecular sieve can be determined by starting with the weight percent of coke relative to the total catalyst weight, and then dividing by the weight fraction of molecular sieve. In a preferred embodiment of the invention, the weight fraction of molecular sieve within the SAPO catalyst is 0.45.

In various embodiments, operating at an increased level of coke on regenerated catalyst can lead to reduced degradation of catalyst, in part due to a lower catalyst residence time in the regenerator for burning a desired coke load. However, operating at increased levels of coke on regenerated catalyst requires selection of targeted regeneration conditions so that the increased coke level is maintained without causing excessive afterburn or other undesired side effects. Additionally, the targeted regeneration conditions should maintain the desired coke level during steady state operation of the reaction system, i.e., the average coke level on catalyst in the reactor should stay at a desired level, and the amount of coke remaining on catalyst particles exiting the regenerator should remain at a desired level. In an embodiment, the average coke level on catalyst in the reactor is at least 2.25% by weight relative to the total weight of catalyst, or at least 3% by weight, or at least 5% by weight, or at least 6% by weight. In preferred embodiments, the coke content of the catalyst at the point where the (oxygenate) feedstock contacts/mixes with the regenerated catalyst is at least about 0.5 wt %, as measured on the molecular sieve, and/or at least about 1 wt %, as measured on the catalyst composition (e.g., including binder, matrix, etc.). In other preferred embodiments, the coke content of the catalyst at the point where the (oxygenate) feedstock contacts/mixes with the regenerated catalyst may additionally or alternately be no greater than about 2 wt %, for example no greater than about 1.2 wt %, as measured on the molecular sieve, and/or no greater than about 4 wt %, for example no greater than about 2.4 wt %, as measured on the catalyst composition (e.g., including binder, matrix, etc.).

The regeneration is conducted at temperatures that are designed to effectively remove coke in an industrially practical amount of time while reducing the likelihood of catalyst damage or degradation. In an embodiment, the regeneration temperature is 730° C. or less, or 700° C. or less, or 675° C. or less, or 650° C., or 625° C. or less. In another embodiment, the regeneration temperature can be 500° C. or greater, or 540° C. or greater, or 590° C. or greater, or 600° C. or greater, or 625° C. or greater.

In one embodiment, the regeneration pressure may be in the range of from about 5 psig (69 kPaa) to about 60 psig (828 kPaa). Preferably, the regeneration pressure is at least 15 psig (207 kPaa), or at least 20 psig (242 kPaa), or at least 25 psig (275 kPaa). Preferably, the regeneration pressure is 30 psig (414 kPaa) or less. The precise regeneration pressure is generally dictated by the pressure in the reaction system. Higher pressures are typically preferred for lowering equipment size and catalyst inventory; however, higher pressures also increase air blower power and cost. Nevertheless, the regeneration pressure may additionally or alternately be in the range from about 30 psig (414 kPaa) to about 150 psig (2.08 MPaa), for example from about 45 psig (621 kPaa) to about 120 psig (1.65 MPaa) or from about 60 psig (828 kPaa) to about 120 psig (1.65 MPaa).

In another embodiment, the residence time (or catalyst holdup) of the catalyst in the regenerator is at least 10 minutes, or at least 15 minutes, or at least 20 minutes. Alternatively, the residence time in the regenerator can be 30 minutes or less, or 25 minutes or less.

In one embodiment, the rate of catalyst, comprising molecular sieve and any other materials (such as matrix materials, binders, fillers, etc.), recirculated to recontact the feed within the reactor system is from about 1 to about 100 times, more desirably from about 10 to about 80 times, and most desirably from about 10 to about 50 times the total feed rate, by weight, of oxygenates to the reactor.

In another embodiment, a portion of the catalyst, comprising molecular sieve and any other materials (such as matrix materials, binders, fillers, etc.) can be removed from the reactor system for regeneration and for recirculation/reintroduction back to the reactor at a rate (catalyst weight/hour) from about 0.01 times to about 5 times, more desirably from about 0.025 times to about 2 times or from about 0.1 times to about 0.5 times, and most desirably from about 0.1 to about 0.3 times the total feed rate (oxygenate weight/hour) of oxygenates to the reactor system. These rates pertain to the formulated molecular sieve catalyst composition, including non-reactive solids.

Preferably, the amount of oxygen in the regeneration flue gas (i.e., gas which leaves the regenerator) is at least 0.5% by volume, or at least 1.5% by volume, or at least 2.0%, or at least 2.2%, or at least 2.5%. In another embodiment, the amount of oxygen in the regeneration flue gas is not greater than 6.0% by volume, or not greater than 4.0% by volume, or not greater than 3.0% by volume. The amount of oxygen in the gas used to regenerate the coked catalyst (i.e., fresh or feed gas) is typically at least about 15 mole percent, preferably at least about 20 mole percent, and more preferably from about 20 mole percent to about 30 mole percent, based on total amount of regeneration gas fed to the regenerator. Note that an excess of oxygen in the regenerator is desirable when regenerating SAPO type catalysts in order to prevent degradation of the catalyst. It is believed that coke on catalyst will react with oxygen in the SAPO molecular sieve at high temperatures if no other source of oxygen is present. Such a reaction leads to degradation of the molecular sieve.

In an embodiment, a CO oxidation metal is present in the regenerator during regeneration. Preferably the CO oxidation metal is platinum, but other metals such as palladium, vanadium, rhenium, iridium, ruthenium, rhodium, oxmium, chromium, or manganese can also be used. The CO oxidation metal may also be present in an oxidized state, such as in an oxide, sulfide, or other form. During operation of the regenerator, CO oxidation metal is added at least periodically to the reaction system. Periodically or continually adding the CO oxidation metal to the reaction system allows losses of the CO oxidation metal to be replaced, such as losses due to attrition or deactivation of the CO oxidation metal.

A CO oxidation metal such as Pt can be added to a particle, such as a silica/alumina carrier particle, a clay carrier particle, or a SAPO catalyst, by any convenient manner. For example, the CO oxidation metal can be added by impregnating a particle with an aqueous or organic solution containing the desired CO oxidation metal, such as a solution of chloroplatinic acid or platinum acetylacetonate. In an embodiment, Pt can be selected as the CO oxidation metal and added to the regenerator in the form of SAPO catalyst particles impregnated with Pt. In such an embodiment, the concentration of Pt in the SAPO particles can be at least 1 ppmw, or at least 10 ppmw, or at least 50 ppmw, or at least 100 ppmw, or at least 500 ppmw, or at least 1000 ppmw. Alternatively, the concentration of Pt in the SAPO particles can be 5000 ppmw or less, or 1000 ppmw or less, or 500 ppmw or less. In a preferred embodiment, only a fraction of SAPO catalyst particles are impregnated with Pt. In such an embodiment, the concentration of Pt in the SAPO particles can be at least 700 ppmw, or at least 750 ppmw, or at least 800 ppmw. Alternatively, the concentration of Pt in the SAPO particles can be 5000 ppmw or less, or 1000 ppmw or less.

Due to the high attrition resistance of SAPO particles, relatively few SAPO particles containing Pt will be lost. This allows the Pt addition rate to be 0.1 ppmw or less per unit of catalyst in the catalyst inventory per day of the overall reaction system, or 0.05 ppmw or less. In another embodiment, the Pt can be added as a separate carrier particle, such as Intercat COP-850, Grace Davison CP-3, or any other similar commercial Pt additive. These particles have higher attrition rates than SAPO catalysts. In embodiments where the attrition rate of the Pt-containing particles is higher, the Pt addition rate can be 10 ppmw or less per unit catalyst inventory per day, or 1 ppmw or less, or 0.5 ppmw or less, or 0.35 ppmw or less, or 0.25 ppmw or less, or 0.20 ppmw or less.

The burning of coke in the regeneration step is an exothermic reaction. When some amount of coke remains on the catalyst after leaving the regenerator fluidized catalyst bed by entrainment, additional coke can be consumed in the region above the regenerator fluidized catalyst bed after the catalyst leaves the regenerator bed if excess oxygen is present. This can be referred to as dilute phase burning of the coke. Similarly, any CO present in the gas leaving the fluidized bed and/or exiting the regenerator can also undergo combustion to form CO₂. These two processes causing additional combustion outside of the regenerator fluidized catalyst bed will be referred to as afterburn. The additional combustion of coke and/or CO after leaving the regenerator fluidized catalyst bed results in additional heating of the catalyst, creating the potential for additional damage or degradation. In various embodiments, the combined temperature rise due to afterburn is maintained at 200° C. or less, or at 100° C. or less, or at 50° C. or less.

Regenerating particles to leave coke on the surface of 0.4 wt % or more can also lead to excess CO remaining in the regenerator flue gas. If the level of excess CO is too great, the flue gas will require additional processing before being allowed to exit the reaction system. In various embodiments, the level of CO in the regenerator flue gas is 10,000 ppmv or less, or 1000 ppmv or less, or 500 ppmv or less, or 200 ppmv or less, or 100 ppmv or less.

In an embodiment, the temperature within the regeneration system can be further controlled by various techniques in the art including feeding a cooled gas to the regenerator vessel, operated either in a batch, continuous, or semi-continuous mode, or a combination thereof. A preferred technique involves withdrawing the regenerated catalyst composition from the regeneration system and passing it through a catalyst cooler to form a cooled regenerated catalyst composition. The catalyst cooler, in an embodiment, is a heat exchanger that is located either internal or external to the regeneration system. Other methods for operating a regeneration system are disclosed in U.S. Pat. No. 6,290,916 (controlling moisture).

The regenerated catalyst composition withdrawn from the regeneration system, preferably from the catalyst cooler, is combined with a fresh molecular sieve catalyst composition and/or re-circulated molecular sieve catalyst composition and/or feedstock and/or fresh gas or liquids, and returned to the reactor(s). In one embodiment, the regenerated catalyst composition withdrawn from the regeneration system is returned to the reactor(s) directly, preferably after passing through a catalyst cooler. A carrier, such as an inert gas, feedstock vapor, steam or the like, may be used, semi-continuously or continuously, to facilitate the introduction of the regenerated catalyst composition to the reactor system, preferably to the one or more reactor(s).

By controlling the flow of the regenerated catalyst composition or cooled regenerated catalyst composition from the regeneration system to the reactor system, the optimum level of coke on the molecular sieve catalyst composition entering the reactor is maintained. There are many techniques for controlling the flow of a catalyst composition described in Michael Louge, Experimental Techniques, Circulating Fluidized Beds, Grace, Avidan and Knowlton, eds., Blackie, 1997 (336-337).

In one embodiment, the catalyst regenerator can have certain design parameters that facilitate the regeneration of catalyst particles in the catalyst regenerator, in addition to providing desirable flow characteristics in the separation zone for increasing entrained catalyst retention. The catalyst regenerator can preferably include a regeneration zone into which a regeneration medium and an at least partially coked catalyst from a reactor can be fed. The regeneration zone typically has a first lower end, a first upper end, and a first major length therebetween. The catalyst regenerator also typically includes a separation zone provided to separate entrained catalyst from gaseous components, e.g., combustion products of a regeneration process, and to return the entrained catalyst to the regeneration zone. The separation zone typically has a second lower end, a second upper end, and a second major length therebetween. The separation zone can include a swaged region adjacent the second lower end of the separation zone, and the second lower end can advantageously be in fluid communication with the first upper end. The catalyst regenerator also typically includes a catalyst return into which regenerated catalyst can be fed from the regeneration zone and from which the regenerated catalyst can be directed to the reactor. According to one embodiment, the ratio of the second major length to the first major length can be greater than 1.0, greater than 1.25, greater than 1.5, greater than 2.0, greater than 3.0, greater than 4.0 or greater than 5.0. Where indicated herein, these ratios are exclusive of the swaged region. If not so indicated, then these ratios are inclusive of the swaged region, which will be factored into the second major length. By providing a catalyst regenerator having these characteristics, desirable regeneration characteristics that minimize entrained catalyst loss can be achieved, as disclosed, for example, in U.S. Patent Application Publication No. 2005-0043577 A1, the entire disclosure of which is fully incorporated by reference herein.

In an embodiment, the separation zone can advantageously include a swaged region and an upper separation region. The swaged region can typically include a narrow end and a broad end and can increase in lateral cross-sectional area from the narrow end to the broad end. The narrow end is generally oriented at the proximal end of the swaged region, while the broad end is generally oriented adjacent the distal end of the swaged region. The broad end of the swaged region is generally adjacent to, and in fluid communication with, the upper separation region. The narrow end is generally oriented adjacent to, and is in fluid communication with, the regeneration zone. The increase in cross-sectional area in swaged region can be provided in order to reduce the superficial velocity of entrained catalyst as the catalyst passes from the narrow end to the broad end of swaged region. The upper separation region preferably is formed of a hollow cylinder, e.g., a tubular member, having a uniform or substantially uniform lateral cross-sectional area, to provide uniform superficial velocity characteristics for entrained catalyst contained therein.

In one embodiment, the ratio of the height of the separation zone to the height of the regeneration zone is greater than about 1, preferably greater than about 1.25, greater than about 1.5, greater than about 2.0, alternately greater than about 3.0, greater than about 4.0, or greater than about 5.0.

Optionally, the regeneration zone has a first average diameter, and the separation zone has a second average diameter. The ratio of the second average diameter to the first average diameter can be at least about 1.1, at least about 1.4, at least about 1.7, at least about 2.0, at least about 2.3, at least about 2.6, or at least about 2.9. Where indicated herein, these ratios are exclusive of the swaged region. If not so indicated, then these ratios are inclusive of the swaged region, which will be factored in determining the second average diameter.

In terms of cross-sectional areas, the regeneration zone can have a first average cross-sectional area, and the separation zone can have a second average cross-sectional area, and the ratio of the second average cross-sectional area to the first average cross-sectional area optionally can be at least about 1.2, at least about 2.0, at least about 3.0, at least about 4.0, at least about 5.3, at least about 6.8, or at least about 8.5. In one embodiment, the ratio of the average cross sectional area of the separation zone to the average cross sectional area of the regeneration zone is from about 1 to about 8.0, preferably from about 1.5 to about 3.0, and most preferably from about 2.0 to about 2.5. Where indicated herein, these ratios are exclusive of the swaged region. If not so indicated, then these ratios are inclusive of the swaged region, which will be factored in determining the second average cross-sectional area. These parameters are particularly well-suited for receiving at least partially coked catalyst from a methanol-to-olefin reactor.

In one embodiment, the ratio of the flow rate of catalyst entering the catalyst regenerator to the length of the regeneration zone and/or the length of the separation zone is greater than about 0.3 lb/sec/ft (0.45 kg/sec/m), optionally greater than about 1.0 lb/sec/ft (1.5 kg/sec/m), and optionally greater than about 6.0 lbs/sec/ft (9.0 kg/sec/m), based on the total lengths of the regeneration and separation zones.

In another embodiment, the present invention is directed to a process for regenerating catalyst. The process can include the steps of: (a) receiving a coked catalyst in a regeneration zone from a reactor; (b) contacting the coked catalyst with a regeneration medium in the regeneration zone at a first superficial velocity and under conditions effective to convert at least a portion of the coked catalyst to regenerated catalyst and forming gaseous products; (c) directing the gaseous products and entrained catalyst from the regeneration zone to a separation zone, wherein the entrained catalyst flows in the separation zone at a second superficial velocity; (d) separating a majority of the gaseous products in the separation zone from a majority of the entrained catalyst in the separation zone; (e) returning the majority of the entrained catalyst to the regeneration zone; and (f) directing the regenerated catalyst from the regeneration zone to the reactor, wherein the ratio of the first superficial velocity to the second superficial velocity is at least about 1.2, at least about 2.0, at least about 3.0, at least about 4.0, at least about 5.3, at least about 6.8, or at least about 8.5. Where indicated herein, these ratios are exclusive of the superficial velocity of the swaged region. If not so indicated, then these ratios are inclusive of the superficial velocity in the swaged region, which will be factored into determining the second superficial velocity. The second superficial velocity optionally is less than about 1.0 meters per second, less than about 0.5, less than about 0.25, or less than about 0.1 meters per second. If so indicated, these velocities are exclusive of the superficial velocity in the swaged region.

In another embodiment, the present invention is directed to a process for regenerating catalyst, which comprises the steps of: (a) receiving a coked catalyst in a regeneration zone from a reactor; (b) contacting the coked catalyst with a regeneration medium in the regeneration zone at a first superficial velocity and under conditions effective to convert at least a portion of the coked catalyst to regenerated catalyst and forming gaseous products; (c) directing the gaseous products and entrained catalyst from the regeneration zone to a separation zone, wherein the entrained catalyst flows in the separation zone at a second superficial velocity, the second superficial velocity being less than the first superficial velocity; (d) separating a majority of the gaseous products in the separation zone from a majority of the entrained catalyst in the separation zone; (e) returning the majority of the entrained catalyst to the regeneration zone; (f) releasing a flue gas stream comprising the majority of the gaseous products from the separation zone, wherein the flue gas stream contains less than about 0.5, less than about 0.05, or less than about 0.005 weight percent entrained catalyst, based on the total weight of the flue gas stream; and (g) directing the regenerated catalyst from the regeneration zone to the reactor. Optionally, the ratio of the first superficial velocity to the second superficial velocity is at least about 1.2, at least about 2.0, at least about 3.0, at least about 4.0, at least about 5.3, at least about 6.8, or at least about 8.5. The second superficial velocity can be less than about 1.0 meters per second, less than about 0.5, less than about 0.25, or less than about 0.1 meters per second. Preferably, the reactor is a methanol-to-olefin reactor, and the process includes the step of contacting methanol in the reactor with a molecular sieve catalyst under conditions effective to convert at least a portion of the methanol to light olefins and to form the coked catalyst.

In another embodiment, the regenerator conditions in an oxygenate-to-olefin reactor system can be described by a dimensionless variable, termed RgI/RxI, which represents the ratio of the catalyst inventory of the regenerator to the catalyst inventory of the reactor. As used herein, the inventory ratio, RgI/RxI, can represent a weight ratio (wt/wt) or a time ratio (s/s), as the catalyst inventory of both the regenerator and the reactor are changing at known flow rates. RgI/RxI, unless otherwise specified herein, is expressed as a steady state variable, e.g., as measured on average over an appropriate sample period of time on a continuous (e.g., oxygenates-to-olefins) process, although the inventory ratio can also be used to represent non-steady state reactor/regenerator conditions herein.

In one embodiment, RgI/RxI can range from about 0.1 to about 0.9, preferably from about 0.1 to about 0.8, for example from about 0.15 to about 0.75, from about 0.2 to about 0.7, or from about 0.25 to about 0.7. In alternate embodiments, RgI/RxI can range from about 0.1 to about 0.6, from about 0.15 to about 0.5, from about 0.3 to about 0.9, from about 0.35 to about 0.85, from about 0.4 to about 0.8, or from about 0.4 to about 0.75.

It has been noted that RgI/RxI can vary with, inter alia, catalyst activity and regenerator temperature, as well as with desired level of coke on catalyst exiting the regenerator.

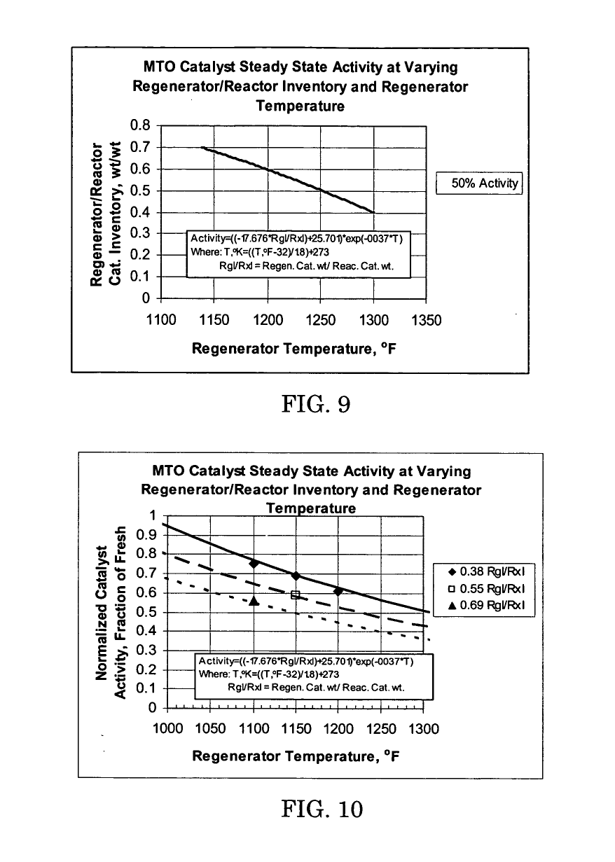

For instance, FIG. 9 shows a plot modeling the variation of inventory ratio (RgI/RxI) with regenerator temperature at constant (in this case, 50%) catalyst steady state activity in a methanol-to-olefin reaction system. From this plot, a relationship of regenerator temperature, inventory ratio, and steady state catalyst activity was determined. Such relationship can be expressed generally with steady state catalyst activity (A_{cat,ss}) being exponentially related to temperature (T), with the pre-exponent “constant” (K) being a linear function of inventory ratio (RgI/RxI), as follows: A_{cat,ss}=K*exp(−E*T); where K=((M*RgI/RxI)+b). Under the conditions of about 0.3% per day of inventory catalyst loss (e.g., due to attrition, catalyst withdrawal, or the like, or combinations thereof), approximately 2.5% flue gas oxygen content, and about 4 psia regenerator water/moisture partial pressure, the constants E, M, and b above fit to about 0.0037, about −17.7, and about 25.7, respectively, when temperature is expressed in degrees Kelvin. In FIG. 9, it is believed that higher activities yield curves on this plot below the 50% activity curve, while lower activities yield curves on the plot above the 50% activity curve.

Further, FIG. 10 shows overlaid plots of modeling done on steady state catalyst activity, varying regenerator temperature and inventory ratio (RgI/RxI). The same methanol-to-olefin reaction system conditions were used for the modeling in FIG. 9 as were used in FIG. 10 to generate multiple plots of constant inventory ratio (RgI/RxI), while varying (normalized) steady state catalyst activity and regenerator temperature. The modeling fit calculated for 50% catalyst activity in FIG. 9 was used for each of the multiple plots of constant inventory ratio (RgI/RxI).

### III. MOLECULAR SIEVE MATERIAL

The molecular sieves used in the present invention are preferably silicoaluminophosphate (SAPO) molecular sieves, aluminophosphate (AlPO) molecular sieves, aluminosilicates (e.g., high-silica CHA-type materials), metal substituted versions thereof, and/or combinations thereof. In an embodiment, the metal is an alkali metal of Group IA of the Periodic Table of Elements, an alkaline earth metal of Group IIA of the Periodic Table of Elements, a rare earth metal of Group IIIB, including the Lanthanides: lanthanum, cerium, praseodymium, neodymium, samarium, europium, gadolinium, terbium, dysprosium, holmium, erbium, thulium, ytterbium and lutetium; and scandium or yttrium of the Periodic Table of Elements, a transition metal of Groups IVB, VB, VIB, VIIB, VIIIB, and IB of the Periodic Table of Elements, or mixtures of any of these metal species. In one preferred embodiment, the metal is selected from the group consisting of Co, Cr, Cu, Fe, Ga, Ge, Mg, Mn, Ni, Sn, Ti, Y, Zn, and Zr, and mixtures thereof. In another preferred embodiment, these metal atoms discussed above are inserted into the framework of a molecular sieve through a tetrahedral unit, such as [MeO₂], and carry a net charge depending on the valence state of the metal substituent. For example, in one embodiment, when the metal substituent has a valence state of +2, +3, +4, +5, or +6, the net charge of the tetrahedral unit is between −2 and +2.

In one embodiment, the silicoaluminophosphate molecular sieve is represented, on an anhydrous basis, by the formula:
mR:(SiₓAl_{y}P_{z})O₂
wherein R represents at least one templating agent, preferably an organic templating agent; m is the number of moles of R per mole of (SiₓAl_{y}P_{z})O₂ and m has a value from 0 to 1, preferably 0 to 0.5, and most preferably from 0 to 0.3; x, y, and z represent the mole fraction of Al, P and Si as tetrahedral oxides. In an embodiment, m is greater than or equal to 0.2, and x, y and z are greater than or equal to 0.01. In another embodiment, m is greater than 0.1 to about 1, x is greater than 0 to about 0.25, y is in the range of from 0.4 to 0.5, and z is in the range of from 0.25 to 0.5, more preferably m is from 0.15 to 0.7, x is from 0.01 to 0.2, y is from 0.4 to 0.5, and z is from 0.3 to 0.5.

In one embodiment, the silicoaluminophosphate molecular sieves have an Si/Al ratio of not greater than about 0.5, preferably not greater than about 0.3, more preferably not greater than about 0.2, still more preferably not greater than about 0.15, and most preferably not greater than about 0.1. In another embodiment, the Si/Al ratio is sufficiently high to allow for increased catalytic activity of the molecular sieve. Preferably, the silicoaluminophosphate molecular sieves contain Si and Al at a ratio of at least about 0.005, more preferably at least about 0.01, and most preferably at least about 0.02.

Non-limiting examples of SAPO molecular sieves useful herein include one or a combination of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, and metal containing molecular sieves thereof. Particularly useful molecular sieves include, but are not limited to, one or a combination of SAPO-18, SAPO-34, SAPO-35, SAPO-44, SAPO-56, AlPO-18, AlPO-34, and metal containing derivatives thereof, such as one or a combination of SAPO-18, SAPO-34, AlPO-34, AlPO-18, and metal containing derivatives thereof, and especially one or a combination of SAPO-34, AlPO-18, and metal containing derivatives thereof.

Other non-limiting examples of zeolitic and non-zeolitic molecular sieves include one or a combination of the following: Beta (U.S. Pat. No. 3,308,069), ZSM-5 (U.S. Pat. Nos. 3,702,886, 4,797,267 and 5,783,321), ZSM-11 (U.S. Pat. No. 3,709,979), ZSM-12 (U.S. Pat. No. 3,832,449), ZSM-12 and ZSM-38 (U.S. Pat. No. 3,948,758), ZSM-22 (U.S. Pat. No. 5,336,478), ZSM-23 (U.S. Pat. No. 4,076,842), ZSM-34 (U.S. Pat. No. 4,086,186), ZSM-35 (U.S. Pat. No. 4,016,245, ZSM-48 (U.S. Pat. No. 4,397,827), ZSM-58 (U.S. Pat. No. 4,698,217), MCM-1 (U.S. Pat. No. 4,639,358), MCM-2 (U.S. Pat. No. 4,673,559), MCM-3 (U.S. Pat. No. 4,632,811), MCM-4 (U.S. Pat. No. 4,664,897), MCM-5 (U.S. Pat. No. 4,639,357), MCM-9 (U.S. Pat. No. 4,880,611), MCM-10 (U.S. Pat. No. 4,623,527), MCM-14 (U.S. Pat. No. 4,619,818), MCM-22 (U.S. Pat. No. 4,954,325), MCM-41 (U.S. Pat. No. 5,098,684), M-41S (U.S. Pat. No. 5,102,643), MCM-48 (U.S. Pat. No. 5,198,203), MCM-49 (U.S. Pat. No. 5,236,575), MCM-56 (U.S. Pat. No. 5,362,697), ALPO-11 (U.S. Pat. No. 4,310,440), titanium aluminosilicates (TASOs) such as TASO-45 (European Patent No. EP-A-0 229 295), boron silicates (U.S. Pat. No. 4,254,297), titanium aluminophosphates (TAPOs) (U.S. Pat. No. 4,500,651), mixtures of ZSM-5 and ZSM-11 (U.S. Pat. No. 4,229,424), ECR-18 (U.S. Pat. No. 5,278,345), SAPO-34 bound ALPO-5 (U.S. Pat. No. 5,972,203), those disclosed in International Publication No. WO 98/57743 published Dec. 23, 1988 (molecular sieve and Fischer-Tropsch), those disclosed in U.S. Pat. No. 6,300,535 (MFI-bound zeolites), mesoporous molecular sieves (U.S. Pat. Nos. 6,284,696, 5,098,684, 5,102,643 and 5,108,725), and the like, and intergrowths and/or combinations thereof. The entire disclosure of each of the references in this paragraph is hereby fully incorporated by reference herein.

In an embodiment, the molecular sieve is an intergrowth material having two or more distinct crystalline phases within one molecular sieve composition, such as a molecular sieve composition containing SAPO-18, which has an AEI framework-type, and SAPO-34, which has a CHA framework-type. Thus, the molecular sieve used herein may comprise at least one intergrowth phase of AEI and CHA framework-types, especially where the ratio of CHA framework-type to AEI framework-type, as determined by the DIFFaX method disclosed in U.S. Patent Application Publication No. 2002-0165089, is greater than 1:1.

The molecular sieves are made or formulated into catalysts by combining the synthesized molecular sieves with a binder and/or a matrix material to form a molecular sieve catalyst composition or a formulated molecular sieve catalyst composition. This formulated molecular sieve catalyst composition is formed into useful shape and sized particles by conventional techniques such as spray drying, pelletizing, extrusion, and the like.

In an embodiment, a molecular sieve catalyst can be characterized according to an Attrition Rate Index (ARI). The ARI methodology is similar to the conventional Davison Index method. The smaller the ARI, the more resistant to attrition; hence, the harder the catalyst. The ARI is measured by adding 6.0±0.1 g of catalyst, having a particle size ranging from 53 to 125 microns, into a hardened steel attrition cup. Approximately 23,700 scc/min of nitrogen gas is bubbled through a water-containing bubbler to humidify the nitrogen. The wet nitrogen is passed through the attrition cup, and exits the attrition apparatus through a porous fiber thimble. The flowing nitrogen removes the finer particles, with the larger particles being retained in the cup. The porous fiber thimble separates the fine catalyst particles from the nitrogen that exits through the thimble. The fine particles remaining in the thimble represent catalyst that has broken apart through attrition.

The nitrogen flow passing through the attrition cup is maintained for 1 hour. Fines collected in the thimble are removed from the unit, and a new thimble installed. The catalyst left in the attrition unit is attrited for an additional 3 hours, under the same gas flow and moisture levels. The fines collected in the thimble are recovered. The collection of fine catalyst particles separated by the thimble after the first hour are weighed. The amount in grams of fine particles divided by the original amount of catalyst charged to the attrition cup expressed on per hour basis is the ARI, in wt %/hr.
ARI=[C/(B+C)/D]×100%
wherein

B=weight of catalyst left in the cup after the attrition test;

C=weight of collected fine catalyst particles after the first hour of attrition treatment; and

D=duration of treatment in hours after the first hour attrition treatment. In an embodiment, the molecular sieve catalyst of this invention has an ARI of not greater than about 0.6 wt %/hr. Preferably, the molecular sieve catalyst has an ARI of not greater than about 0.5 wt %/hr, more preferably not greater than about 0.4 wt %/hr.

### IV. OXYGENATE TO OLEFIN REACTION SYSTEMS

An example of a reaction system that benefits from this invention is an oxygenate-to-olefin process. Conventionally, oxygenate-to-olefin processes are carried out in a fluidized bed, fast fluidized bed, or riser reactor configuration where a fluid (gas) flow of a feedstock is passed through a bed of solid catalyst particles. More generally, the processes of this invention are applicable to gas-solids reaction systems where the solids are separated from the gas flow at some point during the reaction process, including systems where the gas is inert. The examples below describe an oxygenate to olefin reaction system that can be improved using the separation process of the invention.

Oxygenates used in this invention include one or more organic compound(s) containing at least one oxygen atom. In the most preferred embodiment of the process of invention, the oxygenate in the feedstock is one or more alcohol(s), preferably aliphatic alcohol(s) where the aliphatic moiety of the alcohol(s) has from 1 to 20 carbon atoms, preferably from 1 to 10 carbon atoms, and most preferably from 1 to 4 carbon atoms. The alcohols useful as feedstock in the process of the invention include lower straight and branched chain aliphatic alcohols and their unsaturated counterparts. Non-limiting examples of oxygenates include methanol, ethanol, n-propanol, isopropanol, methyl ethyl ether, dimethyl ether, diethyl ether, di-isopropyl ether, formaldehyde, dimethyl carbonate, dimethyl ketone, acetic acid, and mixtures thereof. In the most preferred embodiment, the feedstock is selected from one or more of methanol, ethanol, dimethyl ether, diethyl ether or a combination thereof, more preferably methanol and dimethyl ether, and most preferably methanol.

The feedstock, in one embodiment, contains one or more diluent(s), typically used to reduce the concentration of the feedstock, and are generally non-reactive to the feedstock or molecular sieve catalyst composition. Non-limiting examples of diluents include helium, argon, nitrogen, carbon monoxide, carbon dioxide, water, essentially non-reactive paraffins (especially alkanes such as methane, ethane, and propane), essentially non-reactive aromatic compounds, and mixtures thereof. The most preferred diluents are water and nitrogen, with water being particularly preferred.

The diluent is either added directly to a feedstock entering into a reactor or added directly into a reactor, or added with a molecular sieve catalyst composition. In one embodiment, the amount of diluent in the feedstock is in the range of from about 1 to about 99 mole percent based on the total number of moles of the feedstock and diluent, preferably from about 1 to 80 mole percent, more preferably from about 5 to about 50, most preferably from about 5 to about 25. In another embodiment, other hydrocarbons are added to a feedstock either directly or indirectly, and include olefin(s), paraffin(s), aromatic(s) (see for example U.S. Pat. No. 4,677,242, addition of aromatics) or mixtures thereof, preferably propylene, butylene, pentylene, and other hydrocarbons having 4 or more carbon atoms, or mixtures thereof.

In a conventional oxygenate to olefin reaction, a feed containing an oxygenate is contacted in a reaction zone of a reactor apparatus with a molecular sieve catalyst at process conditions effective to produce light olefins, i.e., an effective temperature, pressure, WHSV (weight hour space velocity) and, optionally, an effective amount of diluent, correlated to produce light olefins. Usually, the oxygenate feed is contacted with the catalyst when the oxygenate is in a vapor phase. Alternately, the process may be carried out in a liquid or a mixed vapor/liquid phase. When the process is carried out in a liquid phase or a mixed vapor/liquid phase, different conversions and selectivities of feed-to-product may result depending upon the catalyst and reaction conditions. As used herein, the term reactor includes not only commercial scale reactors but also pilot sized reactor units and lab bench scale reactor units.

The conversion of oxygenates to produce light olefins may be carried out in a variety of large scale catalytic reactors, including, but not limited to, fluid bed reactors and concurrent riser reactors as described in Fluidization Engineering, D. Kunii and O. Levenspiel, Robert E. Krieger Publishing Co. NY, 1977. Additionally, countercurrent free fall reactors may be used in the conversion process. See, for example, U.S. Pat. No. 4,068,136 and Fluidization and Fluid-Particle Systems, pages 48-59, F. A. Zenz and D. F. Othmer, Reinhold Publishing Corp., NY 1960.

In one embodiment of this invention, the gas and solid particles are flowed through the gas-solids reactor system at a weight hourly space velocity (WHSV) of from about 1 hr⁻¹ to about 5,000 hr⁻¹, preferably from about 5 hr⁻¹ to about 3,000 hr⁻¹, more preferably from about 10 hr⁻¹ to about 1,500 hr⁻¹, and most preferably from about 20 hr⁻¹ to about 1,000 hr⁻¹. In one preferred embodiment, the WHSV is greater than 25 hr⁻¹, and up to about 500 hr⁻¹. In this invention, WHSV is defined as the total weight per hour of the gas flowing between reactor walls divided by the total weight of the solids flowing between the same segment of reactor walls. The WHSV is maintained at a level sufficient to keep the catalyst composition in a fluidized state within a reactor.

In another embodiment of the invention directed toward use of cyclones in conjunction with a riser reactor, the gas and solid particles are flowed through the gas-solids reactor system at a gas superficial velocity (GSV) at least 1 meter per second (m/sec), preferably greater than 2 m/sec, more preferably greater than 3 m/sec, and most preferably greater than 4 m/sec. The GSV should be sufficient to maintaining the solids in a fluidized state, particularly in a fast fluidized state.

In still another embodiment, cyclones configured according to this invention can be used with a fixed fluidized bed reactor. In such an embodiment, the GSV can be as low as 0.03 m/s.

In yet another embodiment of the invention, the solids particles and gas are flowed through the gas-solids reactor at a solids loading of at least 0.1 lb/ft³ (1.6 kg/m³), or at least 0.5 lb/ft³ (8 kg/m³), or at least 1.0 lb/ft³ (16 kg/m³), or at least 2.0 lb/ft³ (32 kg/m³), or at least 4.0 lb/ft³ (64 kg/m³). Alternatively, the solids loading can be 5 lb/ft³ (80 kg/m³) or less, or 4.0 lb/ft³ (64 kg/m³) or less, or 2.0 lb/ft³ (32 kg/m³) or less.

In one practical embodiment, the process is conducted as a fluidized bed process or high velocity fluidized bed process utilizing a reactor system, a regeneration system and a recovery system. In such a process the reactor system conveniently includes a fluid bed reactor system having a first reaction region consisting of various fast fluid or dense fluid beds in series or parallel and a second reaction region within at least one disengaging vessel, comprising two or more cyclones configured and/or operated according to various embodiments of the invention. In one embodiment, the fast fluid or dense fluid beds and disengaging vessel are contained within a single reactor vessel. Fresh feedstock, preferably containing one or more oxygenates, optionally with one or more diluent(s), is fed to the one or more fast fluid or dense fluid beds reactor(s) into which a molecular sieve catalyst composition or coked version thereof is introduced. In one embodiment, prior to being introduced to the reactor(s), the molecular sieve catalyst composition or coked version thereof is contacted with a liquid and/or vapor, preferably water and methanol, and a gas, for example, an inert gas such as nitrogen.

In an embodiment, the amount of fresh feedstock fed as a liquid and/or a vapor to the reactor system is in the range of from 0.1 weight percent to about 99.9 weight percent, such as from about 1 weight percent to about 99 weight percent, more typically from about 5 weight percent to about 95 weight percent based on the total weight of the feedstock including any diluent contained therein. The liquid and vapor feedstocks may be the same composition, or may contain varying proportions of the same or different feedstocks with the same or different diluents.

The process of this invention can be conducted over a wide range of temperatures, such as in the range of from about 200° C. to about 1000° C., for example from about 250° C. to about 800° C., including from about 250° C. to about 750° C., conveniently from about 300° C. to about 650° C., typically from about 350° C. to about 600° C., and for example from about 350° C. to about 550° C.

Similarly, the process of this invention can be conducted over a wide range of pressures including autogenous pressure. For instance, light olefins will form, though not necessarily in optimal amounts, at a wide range of pressures including, but not limited to, pressures from about 0.1 kPaa to about 5 MPaa, such as from about 5 kPaa to about 1 MPaa, and conveniently from about 20 kPaa to about 500 kPaa. The foregoing pressures do not include that of a diluent, if any, and refer to the partial pressure of the feed as it relates to oxygenate compounds and/or mixtures thereof. Pressures outside of the stated ranges may be used and are not excluded from the scope of the invention. Lower and upper extremes of pressure may adversely affect selectivity, conversion, coking rate, and/or reaction rate; however, light olefins will still form and, for that reason, these extremes of pressure are considered part of the present invention.

In embodiments involving a riser reactor, the solids particles and gas are flowed through the gas-solids reactor at a solids to gas mass ratio of about 0.5:1 to about 75:1. Preferably, the solids particles and gas are flowed through the gas-solids reactor at a solids to gas mass ratio of about 8:1 to about 50:1, more preferably from about 10:1 to about 40:1.

During the conversion of a hydrocarbon feedstock, preferably a feedstock containing one or more oxygenates, the amount of olefin(s) produced based on the total weight of hydrocarbon produced is greater than 50 weight percent, typically greater than 60 weight percent, such as greater than 70 weight percent, and preferably greater than 75 weight percent. In one embodiment, the amount of ethylene and/or propylene produced based on the total weight of hydrocarbon product produced is greater than 65 weight percent, such as greater than 70 weight percent, for example greater than 75 weight percent, and preferably greater than 78 weight percent. Typically, the amount of ethylene produced in weight percent based on the total weight of hydrocarbon product produced, is greater than 30 weight percent, such as greater than 35 weight percent, for example greater than 40 weight percent. In addition, the amount of propylene produced in weight percent based on the total weight of hydrocarbon product produced is greater than 20 weight percent, such as greater than 25 weight percent, for example greater than 30 weight percent, and preferably greater than 35 weight percent.

The feedstock entering the reactor system is preferably converted, partially or fully, in a reaction region into a gaseous effluent. In an embodiment, the reaction region is closely coupled to a plurality of separation devices, such as cyclone separators. In another embodiment, the gaseous effluent enters a disengaging vessel along with the coked catalyst composition. In such an embodiment, the disengaging vessel includes cyclone separators configured and/or operated according to the invention. In still another embodiment, the disengaging vessel also includes a stripping zone, typically in a lower portion of the disengaging vessel. In the stripping zone the coked catalyst composition is contacted with a gas, preferably one or a combination of steam, methane, carbon dioxide, carbon monoxide, hydrogen, or an inert gas such as argon, preferably steam, to recover adsorbed hydrocarbons from the coked catalyst composition. After exiting the separation devices and/or disengaging vessels, some or all of the catalyst can then be introduced to the regeneration system.

The gaseous reactor effluent is withdrawn from the disengaging system and is passed through a recovery system. There are many well known recovery systems, techniques and sequences that are useful in separating olefin(s) and purifying olefin(s) from the gaseous effluent. Recovery systems generally comprise one or more or a combination of various separation, fractionation and/or distillation towers, columns, splitters, or trains, reaction systems such as ethylbenzene manufacture and other derivative processes such as aldehydes, ketones and ester manufacture, and other associated equipment, for example various condensers, heat exchangers, refrigeration systems or chill trains, compressors, knock-out drums or pots, pumps, and the like.

Non-limiting examples of these towers, columns, splitters or trains used alone or in combination include one or more of a demethanizer, preferably a high temperature demethanizer, a dethanizer, a depropanizer, a wash tower often referred to as a caustic wash tower and/or quench tower, absorbers, adsorbers, membranes, ethylene (C₂) splitter, propylene (C₃) splitter and butene (C₄) splitter.

Generally accompanying most recovery systems is the production, generation or accumulation of additional products, by-products and/or contaminants along with the preferred prime products. The preferred prime products, the light olefins, such as ethylene and propylene, are typically purified for use in derivative manufacturing processes such as polymerization processes. Therefore, in the most preferred embodiment of the recovery system, the recovery system also includes a purification system. For example, the light olefin(s) produced particularly in a MTO process are passed through a purification system that removes low levels of by-products or contaminants. Typically, in converting one or more oxygenates to olefin(s) having 2 or 3 carbon atoms, a minor amount of hydrocarbons, particularly olefin(s), having 4 or more carbon atoms is also produced. The amount of C₄+ hydrocarbons is normally less than 20 weight percent, such as less than 10 weight percent, for example less than 5 weight percent, and particularly less than 2 weight percent, based on the total weight of the effluent gas withdrawn from the process, excluding water. Typically, therefore the recovery system may include one or more reaction systems for converting the C₄+ impurities to useful products.

### V. EXAMPLES

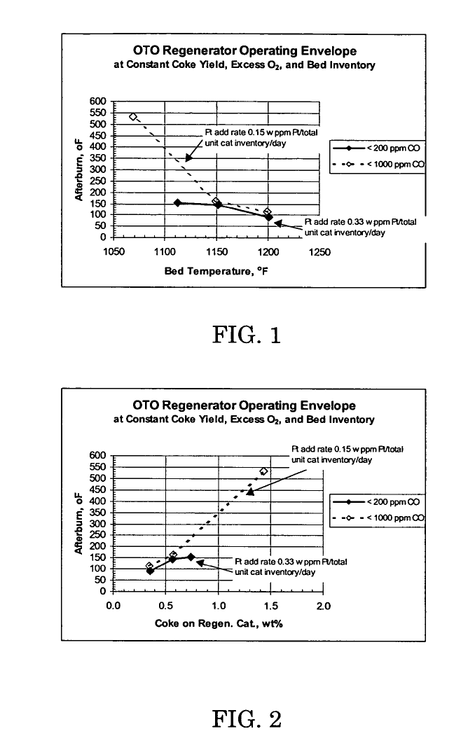

FIGS. 1-6 show data from a regenerator model for several conditions corresponding to embodiments of the claimed invention as well as one comparative example outside of the claimed invention. The regenerator model was developed using data from a pilot plant to incorporate experimental coke burn and CO burn rates/kinetics into the model. In the pilot plant experiments, a SAPO, catalyst was used with a molecular sieve weight fraction of 0.45.

In the data shown in FIGS. 1-6, regenerator simulations were carried out to model a constant coke yield (amount of coke burned per unit time), an excess O₂ amount of 2.3 vol %, and a constant regenerator catalyst holdup of 21 minutes at 5 wt % delta coke (regenerator inlet coke on catalyst minus regenerator outlet coke on catalyst). Simulations were run at temperatures ranging from 575° C. to 650° C., with the simulations at temperatures of 590° C. and greater corresponding to embodiments of the invention. The amount of CO in the flue gas was controlled by controlling the addition rate of new Pt to the reaction system. Note that temperatures in the model were based on an adiabatic regenerator that did not lose heat to its surroundings. This approximates the low heat loss (2-5% of heat generated) that would be expected for a regenerator that is part of a commercial scale reaction system. A catalyst cooler was used to control the regenerator catalyst bed temperature. A CO level of less than 200 ppm CO was produced by using an add rate of 0.33 ppmw Pt per total weight of unit catalyst inventory per day, while a CO level of less than 1000 ppm was achieved using an add rate of 0.15 ppmw Pt per total weight of unit catalyst inventory per day. Note that the Pt add rates are based on using a separate carrier particle for the Pt that has an attrition resistance similar to the resistance for an FCC catalyst particle.

FIG. 1 shows the results for 6 different combinations of Pt addition rates and bed temperatures in the regenerator. For Pt addition rates of 0.33 ppmw Pt per total weight of unit catalyst inventory per day, all of the operating conditions produced an afterburn of 150° F. (80° C.) or less. By contrast, when a fluidized bed temperature of 575° C. was used at a Pt add rate of 0.15 ppmw, a substantially higher afterburn of more than about 500° F. (or more than about 275° C.) occurred in the steady state. This substantial change in the afterburn temperature at bed temperatures below 590° C. was not expected based on conventional understanding of the regeneration process. This provides one example of how departing from the conditions of the claimed invention can lead to either an undesirable process (large afterburn or high CO in flue gas) or an unstable process (i.e., desired coke level or regenerator temperature cannot be maintained). FIG. 2 shows that under the same conditions, the simulations corresponding to the claimed invention produced coke levels on the regenerated catalyst of from 0.4 wt % to 0.7 wt %. However, the simulation having the bed temperature of 575° C. resulted in a coke level of 1.3 wt % on the regenerated particles.

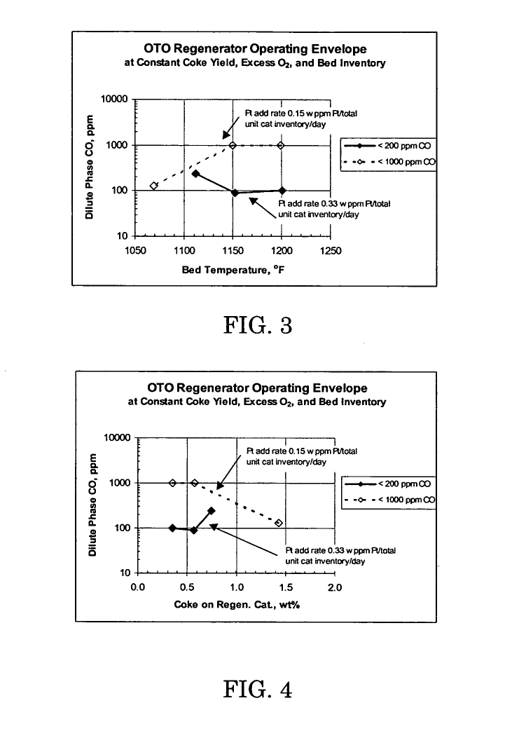

FIGS. 3 and 4 show data from the same simulations, but with the amount of CO in the regenerator flue gas being used as an axis instead of the afterburn temperature. As shown, the embodiments according to the invention produce CO flue gas contents corresponding to the desired levels of less than 200 ppm and less than 1000 ppm, respectively, based on the add rate of Pt. Note that for the comparative example having a bed temperature of 575° C., the CO concentration is greatly reduced from the expected level near 1000 ppm CO, due to the additional afterburn converting CO into CO₂.

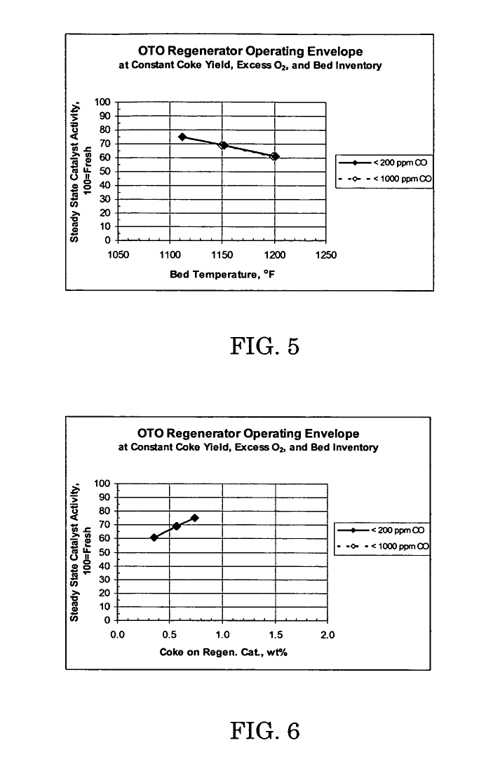

FIGS. 5 and 6 show data from the same simulations regarding the catalyst activity. In various embodiment, the invention provides a method for maintaining the activity of SAPO catalyst in a reaction system relative to the reactivity of fresh catalyst. FIGS. 5 and 6 show catalyst activity that is maintained at from 60% to 75% of fresh catalyst activity. As shown in the figures, the higher the bed temperature, the greater the deactivation of the catalyst due to regeneration. In a preferred embodiment, the regenerator is operated using conditions that maintain the reactivity of the reaction system catalyst inventory at greater than 50% of the reactivity of fresh catalyst inventory, or at greater than 60%.

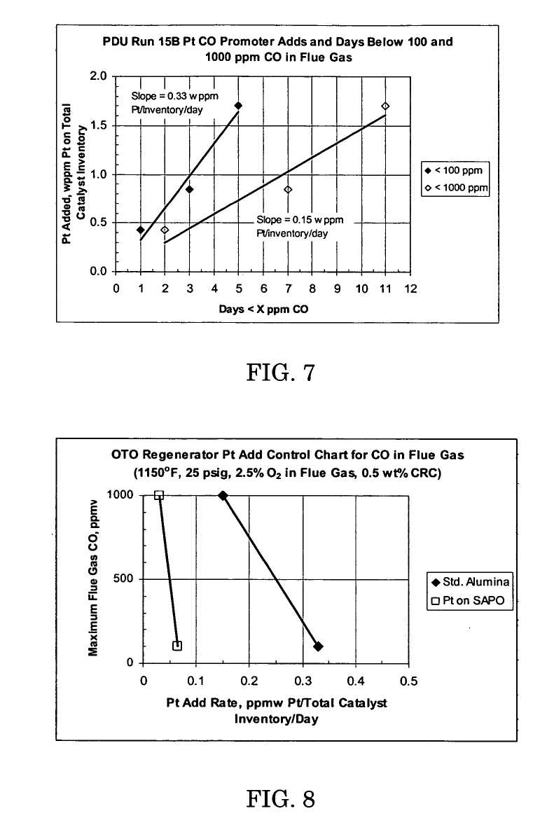

FIG. 7 depicts how, in an embodiment, the periodic addition of Pt contributed to steady state operation of a pilot plant regenerator with a controlled CO level. The pilot plant data was obtained by operating a regenerator in conjunction with an oxygenate to olefin process. The regenerator was operated at 1150° F. and a pressure of 25 psig (275 kPaa), with an excess of 2.5% O₂ in the regenerator flue gas. The coke level on the regenerated catalyst was maintained at 0.5% coke by weight relative to the catalyst weight. In FIG. 7, a Pt add rate of 0.33 wppm Pt per total weight of unit catalyst inventory per day resulted in steady state operation for 5 days with a CO level below 100 wppm. Similarly, a Pt add rate of 0.15 wppm Pt per total weight of unit catalyst inventory per day produced steady state operation for 11 days with a CO level below 1000 wppm.

FIG. 8 depicts the predicted change in the amount of Pt that needs to be added to achieve a desired level of CO output in the flue gas based on the attrition resistance of the particle containing the Pt. In FIG. 8, the separate additive particle used in the examples for FIG. 7 is compared with SAPO particles as the carriers for the Pt. As shown in FIG. 8, the rate of Pt addition to achieve the same level of CO in the regenerator flue gas is reduced by a factor of roughly 5 when using the harder, SAPO particle carrier.

The principles and modes of operation of this invention have been described above with reference to various exemplary and preferred embodiments. As understood by those of skill in the art, the overall invention, as defined by the claims, encompasses other preferred embodiments not specifically enumerated herein.

What is claimed is:

1. A method for regenerating molecular sieve catalyst, comprising:
receiving SAPO catalyst, having at least 5 wt % coke relative to the weight of molecular sieve in the catalyst, from a reactor in an oxygenate to olefin reaction system;
regenerating the SAPO catalyst in a regenerator at a temperature of 730° C. or less to produce regenerated catalyst having at least 0.4 wt % coke relative to the weight of molecular sieve in the regenerated catalyst, the regenerator producing a steady state afterburn of 200° C. or less and a steady state CO concentration in a regenerator flue gas of 10,000 ppmv or less;
adding particles containing a CO oxidation metal to the reaction system at a rate of 10 ppmw of CO oxidation metal per total weight of unit catalyst inventory in the reaction system per day or less, the concentration of CO oxidation metal in the particles being at least 1 ppmw.

2. The method of claim 1, wherein the particles containing the CO oxidation metal comprise SAPO particles containing Pt.

3. The method of claim 2, wherein the particles containing Pt are added to the reaction system at a rate of 0.35 ppmw of Pt per total weight of catalyst in the reaction system per day or less.

4. The method of claim 1, wherein the temperature of the regenerator is at least 590° C.

5. The method of claim 1, wherein a residence time of the catalyst in the regenerator is from 1 minute to 180 minutes.

6. The method of claim 1, wherein the afterburn is 100° C. or less.

7. The method of claim 1, wherein the amount of coke on the catalyst after regeneration is at least 0.6 wt % relative to the weight of molecular sieve in the regenerated catalyst.

8. The method of claim 1, wherein the amount of coke on the catalyst after regeneration is 2.2 wt % or less relative to the weight of molecular sieve in the regenerated catalyst.

9. The method of claim 1, wherein the regenerator flue gas contains a steady state concentration of O₂ of at least 0.5 vol %.

10. The method of claim 1, wherein the regenerator flue gas contains a steady state concentration of CO of 1,000 ppmv or less.

11. The method of claim 1, wherein the regenerator flue gas contains a steady state concentration of CO of 200 ppmv or less.

12. The method of claim 1, wherein the concentration of CO oxidation metal in the particles is at least 10 ppmw.

13. A method for regenerating molecular sieve catalyst, comprising:
receiving SAPO catalyst, having at least 5 wt % coke relative to the weight of molecular sieve in the catalyst, from a reactor in an oxygenate to olefin reaction system;
regenerating the SAPO catalyst in a regenerator at a temperature of from 540° C. to 730° C. and at a pressure of from 5 to 100 psig, to produce regenerated catalyst having from 0.4 wt % coke to 2.2 wt % coke relative to the weight of molecular sieve in the catalyst, the regenerator producing a steady state afterburn of less than 200° C., a steady state CO concentration in a regenerator flue gas of 10,000 ppmv or less, and a steady state of O₂ in the regenerator flue gas of at least 2.0 vol %;
adding particles containing a CO oxidation metal to the reaction system at a rate of 10 ppmw of CO oxidation metal per total weight of catalyst in the reaction system per day or less.

14. The method of claim 13, wherein the particles containing the CO oxidation metal comprise SAPO particles containing Pt.

15. The method of claim 13, wherein the particles containing the CO oxidation metal comprise particles containing Pt that have an Attrition Rate Index (ARI) of less than 1.0.

16. The method of claim 15, wherein the particles containing Pt are added to the reaction system at a rate of 0.35 ppmw of Pt per total weight of catalyst in the reaction system per day or less.

17. The method of claim 13, wherein a residence time of the catalyst in the regenerator is from 5 minutes to 60 minutes.

18. The method of claim 13, wherein the amount of coke on the catalyst after regeneration is at least 0.6 wt % relative to the weight of molecular sieve in the regenerated catalyst.

19. The method of claim 13, wherein the afterburn is 100° C. or less.

20. The method of claim 13, wherein the regenerator flue gas contains a steady state concentration of O₂ of 3.0 vol % or less.

21. The method of claim 13, wherein the regenerator flue gas contains a steady state concentration of CO of 1000 ppmv or less.

22. The method of claim 13, wherein the regenerator flue gas contains a steady state concentration of CO of 200 ppmv or less.

23. The method of claim 13, wherein the steady state activity of the reaction system catalyst inventory is maintained at greater than 50% of fresh catalyst activity when making up catalyst for inventory catalyst losses.

24. A method for regenerating molecular sieve catalyst, comprising:
receiving SAPO catalyst, having at least 5 wt % coke relative to the weight of molecular sieve in the catalyst, from a reactor in an oxygenate to olefin reaction system;
regenerating the SAPO catalyst in a regenerator at a temperature of 730° C. or less to produce regenerated catalyst having at least 0.2 wt % coke relative to the weight of molecular sieve in the regenerated catalyst, the regenerator producing a steady state afterburn of less than 100° C. and a steady state CO concentration in a regenerator flue gas of 1000 ppmv or less;
adding particles containing a CO oxidation metal to the reaction system at a rate of 0.35 ppmw of CO oxidation metal per total weight of unit catalyst inventory in the reaction system per day or less, the concentration of CO oxidation metal in the particles being at least 10 ppmw.

25. A method for regenerating molecular sieve catalyst in an oxygenate-to-olefin reaction system, comprising:
receiving the molecular sieve catalyst, having at least 50% of a pre-determined average coke level in the oxygenate-to-olefin reaction system, relative to the weight of molecular sieve in the catalyst, wherein the reaction system comprises at least a reactor and a regenerator, and wherein, at any given time, the reactor has an inventory of molecular sieve catalyst and the regenerator has an inventory of molecular sieve catalyst;
regenerating the molecular sieve catalyst in the regenerator to produce regenerated catalyst having at least 0.2 wt % coke relative to the weight of molecular sieve in the regenerated catalyst, the regenerator producing a steady state afterburn of 200° C. or less and a steady state CO concentration in a regenerator flue gas of 10,000 ppmv or less, wherein the ratio of the regenerator inventory to the reactor inventory is from about 0.1 to about 0.8; and
adding particles containing a CO oxidation metal to the reaction system at a rate of 10 ppmw of CO oxidation metal per total weight of unit catalyst inventory in the reaction system per day or less, the concentration of CO oxidation metal in the particles being at least 1 ppmw,
wherein the steady state activity of the reaction system catalyst inventory is maintained at greater than 50% of fresh catalyst activity when making up catalyst for inventory catalyst losses.

26. The method of claim 25, wherein the molecular sieve catalyst comprises a silicoaluminophosphate, an aluminophosphate, an aluminosilicate, a metal or metal oxide coated version thereof, an intergrowth thereof, or a combination thereof.

27. The method of claim 26, wherein the ratio of the regenerator inventory to the reactor inventory is from about 0.2 to about 0.7.
